(19) United States
(12) Patent Application Publication
(10) Pub. No.: US 2005/0034936 A1
(43) Pub. Date: Feb. 17, 2005

(54) Electric brake caliper having a ballscrew with integral gear carrier

(75) Inventors: David B. Drennen, Bellbrook, OH (US); Ernest R. Siler, Springboro, OH (US); James R. Waag, Miamisburg, OH (US); Craig A. Osterday, Dayton, OH (US); Ronald G. Smith, New Carlisle, OH (US); Donald E. Holmes, Dayton, OH (US)

Correspondence Address: SCOTT A. MCBAIN;DELPHI TECHNOLOGIES, INC., Mail Code: 480-410-202, P.O. BOX 5052, Troy, MI, 48007, US

(73) Assignee: DELPHI TECHNOLOGIES INC.

(21) Appl. No.: 10/639,946

(22) Filed: Aug. 13, 2003

(51) Int. Cl. F16D 55/08; F16D 55/16

(52) U.S. Cl. 188/72.8

(57) ABSTRACT

An electric brake caliper includes a ball screw apparatus having a cup-shaped ball screw including an annular cylindrical sidewall disposed about a rotational axis and closed at one axial end thereof by an end wall joined around an entire periphery thereof integrally with the sidewall. The end wall is adapted to form a carrier for operatively supporting at least one planetary gear. The ball screw apparatus also includes a ball screw nut operatively engaged with the ball screw. The annular cylindrical sidewall of the ball screw also defines an axial length of the ball screw and a ball track extending about the sidewall along the axial length of the ball screw from starting point that is adjacent to, but axially spaced from, the closed end of the ball screw. The ball track further includes a ball return track.

### TECHNICAL FIELD OF THE INVENTION

This invention relates to brakes, and more particularly to an electrically actuated disk brake caliper.

### BACKGROUND OF THE INVENTION

Since the mid 1930s, vehicles such as automobiles and light trucks have predominantly utilized hydraulic brake systems. For several decades, many of these brake systems have included hydraulically actuated disk brakes, having a brake caliper that clamps brake pads against opposite faces of a rotor disk attached to the wheel of the vehicle. A typical hydraulic caliper includes a piston, which is housed in a cylinder bore in the caliper, for applying the clamping force to the brake pads when the driver steps on a brake pedal of the vehicle.

In the years since hydraulic brake systems became the norm, many additional features have been added, to further enhance safe operation and optimize vehicle performance. Modern brake systems often include a booster that amplifies force exerted on the brake pedal, to provide power brakes that allow a person operating the vehicle to control the brakes with significantly less force on the brake pedal than is required in a non-boosted brake system. Such boosted systems are typically known as power brake systems, or power-assisted brake systems.

Many modern brake systems now also include sophisticated electronic controls for providing controlled braking functions such as anti-lock braking (ABS), traction control systems (TCS), and vehicle stability enhancement (VSE).

As a consequence of the continual evolution of vehicle brake systems toward fully capitalizing on the advantages of electronic control, brake calipers that are actuated electrically, rather than hydraulically, are now entering service in vehicle braking systems. In addition to providing enhanced performance and functionality, electric brake calipers offer advantages in reducing both initial assembly cost of the vehicle and operational cost of the vehicle through elimination of the need for supplying hydraulic fluid to the caliper.

In one form of an electric caliper, an electric motor is coupled to the brake pad through a gear train and a device known as a ball-screw assembly, to apply the clamping force to the brake rotor. Several approached to providing electric calipers of this type are disclosed in commonly assigned United States patents:

6,412,610 B1, titled Electric Brake Caliper, by Drennen, et al; 6,367,593 B1, titled Electric Caliper Having Splined Ball Screw, by Siler, et al; and 6,139,460, titled Electric Caliper, by Drennen, et al.

In order to achieve a desired level of braking force and responsiveness, in a vehicle such as a typical automobile or a light truck, it is necessary for the caliper to produce clamping forces that vary from a few hundred pounds to about fourteen thousand (14,000) pounds, and that the position of the brake pads relative to the rotor be controllable to within a few thousandths of an inch. In calipers of the type disclosed in the commonly owned patents to Drennen, et al, and Siler, et al, this is accomplished by having the shaft of the electric motor, rotate several hundred revolutions for each change in the force applied to the brake pedal, or in response to a command from a computer in the controlled braking system.

The rotating motor shaft is coupled to the ball screw through a gear train that substantially gears down the rotation received from the motor shaft. This gearing down of the motor shaft speed produces a very small rotation at the output of the gear train, which is converted by the ball screw into linear motion that is controllable to within thousandths of an inch, for clamping the brake pads against the rotor. As the rotational speed is geared down, the torque that is produced at the output of the gear train and delivered to the ball screw is proportionately and substantially increased by the gear ratio of the gear train.

In the process of transferring the high torque from the output of the gear train to the ball screw, the components at the output end of the gear train are highly stressed. The commonly assigned patents to Drennen, et al, and Siler, et al, provide various approaches to dealing with these stresses, in a manner that provides an assembly, including the motor, gear train and ball screw, that is compact enough to fit into the limited space available in the caliper. It is desirable, however, to provide an electric caliper that has even greater torque capacity at the output of the gear train, in an assembly that is even more compact and can be manufactured in a more straightforward manner than the electric calipers disclosed in the commonly assigned patents to Drennen, et al, and Siler, et al.

### SUMMARY OF THE INVENTION

Our invention provides an improved electric brake caliper, meeting the requirements discussed above, through use of a ball screw apparatus including a cup-shaped ball screw having an annular cylindrical sidewall disposed about a rotational axis and closed at one axial end thereof by an end wall joined around an entire periphery thereof integrally with the sidewall. The end wall is adapted to form a carrier for operatively supporting at least one planetary gear. The ball screw apparatus also includes a ball screw nut operatively engaged with the ball screw.

The annular cylindrical sidewall of the ball screw may also define an axial length of the ball screw and a ball track extending about the sidewall along the axial length of the ball screw from starting point that is adjacent to, but axially spaced from, the closed end of the ball screw. The ball track may further include a ball return track.

In some forms of an electric caliper, according to our invention, the ball screw nut of the ball screw apparatus may be cup-shaped and include an annular cylindrical sidewall disposed about a rotational axis and closed at one axial end thereof by an end wall joined around an entire periphery thereof integrally with the sidewall of the ball screw nut, with the side wall of the ball screw nut defining an inner surface of the ball screw nut sidewall having a ball track therein. The ball screw apparatus may also include a plurality of balls residing concurrently in the ball tracks in the annular sidewalls of both the ball screw and the ball screw nut.

Our invention may also take the form of a brake apparatus, in which the brake apparatus includes an electric brake caliper according to our invention.

The foregoing and other features and advantages of our invention will become further apparent from the following detailed description of exemplary embodiments, read in conjunction with the accompanying drawings. The detailed description and drawings are merely illustrative of our invention rather than limiting, the scope of the invention being defined by the appended claims and equivalents thereof.

### BRIEF DESCRIPTION OF THE DRAWINGS

FIG. 1 is a cross section of one exemplary embodiment of a brake apparatus including an electric brake caliper having a ball screw apparatus, according to our invention;

FIG. 2 is an exploded perspective drawing including a number of the components of the electric brake caliper of FIG. 1; and

FIGS. 3 and 4 are perspective partial sectional views of a ball screw apparatus of the electric brake caliper of FIGS. 1 and 2.

### DETAILED DESCRIPTION

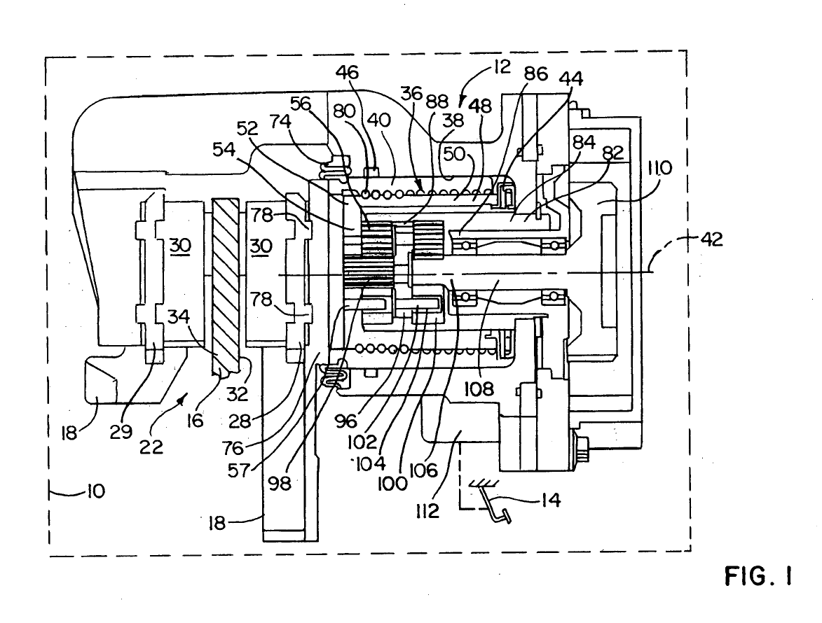

FIG. 1 shows a first exemplary form of a brake apparatus 10 for a vehicle, including an electric brake caliper 12, according to our invention. The brake system 10 includes a brake pedal 14, which communicates a signal, from the driver of the vehicle, to the electric caliper 12.

As shown in FIG. 1, the electric caliper 12 and a brake rotor 16 of the brake apparatus 10 are attached to a common support 18, such as a steering knuckle, or the chassis of a vehicle. The rotor 16 is mounted for rotation with a wheel of the vehicle, about a rotor axis (not shown) coincident with the axis of the axle about which the wheel rotates. The caliper 12 includes a caliper housing 20 that is slidably mounted on a pair of mounting pins (not shown) to the support 18, in a manner known in the art, which allows the caliper 12 to move a short distance toward or away from the support 18, during operation of the brake apparatus 10.

The caliper housing 20 includes a circumferential shaped slot 22 that fits over a portion of the periphery of the rotor 16, to provide clearance for a pair of brake shoes 28, 29 having linings 30 positioned to be clamped against an inboard and an outboard side 32, 34 of the rotor 12. The brake shoes 28, 29 are suspended from the caliper housing 20 in a manner that lets the shoes 28, 29 slide axially with respect to the housing.

The electric caliper 12 includes a ball screw apparatus 36 mounted in a cylinder bore 38 of the caliper housing 20, having a ball screw nut 40 that is movable along a bore axis 42 for moving the inboard brake shoe 28 into contact with the inboard side 32 of the rotor 12, for applying a braking force against the inboard side 32 of the rotor 12, when the ball screw apparatus 36 is actuated, in a manner described in more detail below, in response to the driver depressing the brake pedal 14.

As the ball screw nut 40 applies braking force to clamp the inboard brake shoe 28 against the inboard side 32 of the rotor 12, a reaction force is transferred through the ball screw apparatus 36 and into the caliper housing 20 through a thrust bearing 44, and causes the housing 20 to move in an opposite direction along the bore axis 42. This movement of the housing 20 pulls the outboard lining 30 of the outboard brake shoe 29 into contact with the outboard side 34 of the rotor 12, creating a clamping effect, so that the motion of the ball screw nut 40 toward the inboard side 32 of the rotor 16 applies braking force to both the inboard and outboard sides 32, 34 of the rotor 12.

When the ball screw apparatus 36 ceases to apply force, the ball screw nut 40 is retracted a few thousandths of an inch by the action of a specially designed seal 46, between the cylinder bore 38 and the ball screw nut 40, in a manner known in the art. The ball screw apparatus 36 may also be utilized to pull the ball screw nut 40 away from the rotor 16. With the ball screw nut 40 retracted, the inboard brake shoe 28 is free to move away from the inboard surface 32 of the rotor 12, and minor run out in the brake rotor 16 will cause the outboard shoe 29 to also move away from the rotor 16.

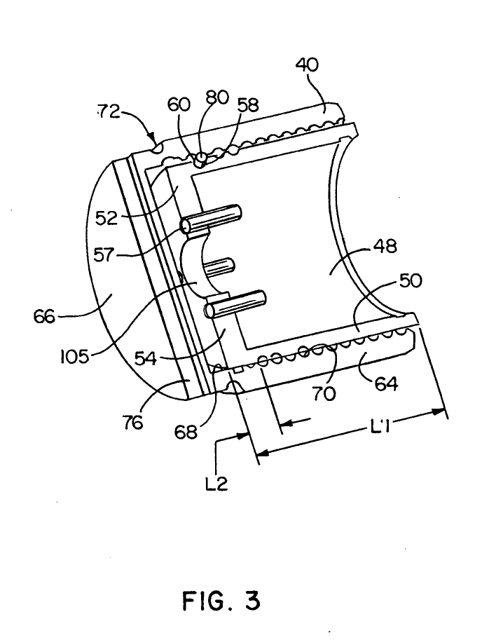

As shown in FIGS. 1 through 4, the ball screw apparatus 36 includes a cup-shaped ball screw 48 having an annular cylindrical sidewall 50, disposed about a rotational axis 51 that is generally coincident with the bore axis 42. The ball screw 48 is closed at one axial end thereof by an end wall 52 joined around an entire periphery thereof integrally with the sidewall 50. The end wall 52 adapted to form a carrier 54 for operatively supporting four planetary gears 56 on four stub shafts 57, (only three of which are visible in FIG. 3) extending from the end wall 52 into the ball screw 48 in a direction parallel to the rotational axis and away from the rotor 16.

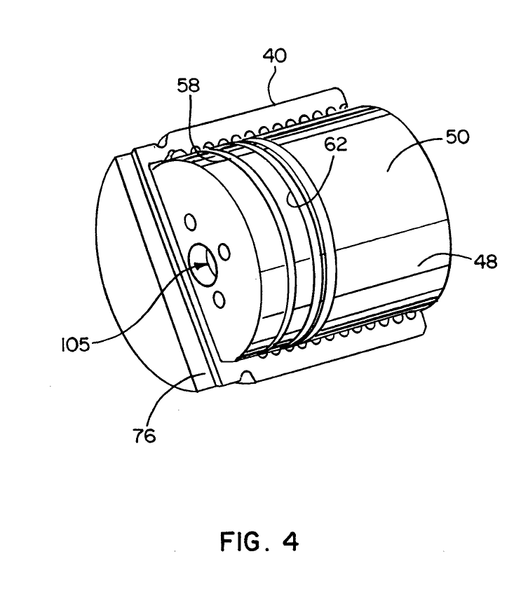

As shown, in FIGS. 3 and 4, the sidewall 50 of the ball screw 48 defines an axial length L1 of the ball screw 48 and a ball track 58 extending about the sidewall 50 along the axial length L1 of the ball screw 48, from starting point 60 that is adjacent to, but axially spaced a distance L2 from, the closed end 52 of the ball screw 48. The ball track 58 is configured to include a ball return track 62.

The ball screw nut 40 of the exemplary embodiment is cup-shaped and includes an annular cylindrical sidewall 64 disposed about the rotational axis 51 and closed at one axial end thereof by an end wall 66 joined around an entire periphery thereof integrally with the sidewall 64 of the ball screw nut 40. The sidewall 64 of the ball screw nut 40 defines an inner surface 68 of the ball screw nut sidewall 64 having a ball track 70 therein. The sidewall 64 of the ball screw nut 40 also defines a groove 72 in an outer surface thereof for receiving an environmental seal 74, as shown in FIGS. 1, and 4. As shown in FIGS. 1-4, the closed end 52 of the ball screw nut 40 also includes a transversely-extending slot 76 that engages with raised nubs 78 on the back side of the inboard brake shoe 28, to preclude rotation of the ball screw nut 40 within the cylinder bore 38. The ball screw apparatus 36 includes a plurality of balls 80 residing concurrently in the ball tracks 58, 70 in the annular sidewalls 50, 64 of both the ball screw 48 and the ball screw nut 40, for transferring axially directed force from the ball screw 48 to the ball screw nut 48.

In the ball screw apparatus 36 of the exemplary embodiment, the carrier 54 formed by the end wall 52 of the ball screw 48 is a second stage carrier 54. The four planetary gears 56 supported on the stub shafts 57 extending from the second stage carrier 54 are second stage planetary gears 56.

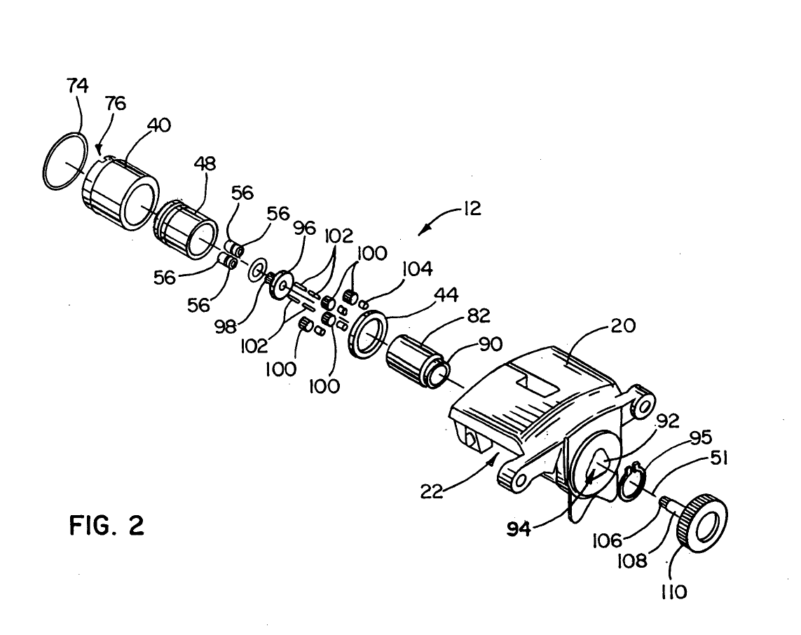

The ball screw apparatus of 36 also includes a ring gear 82 having a tubular shaped wall 84 including an inner surface 86 thereof defining internal gear teeth 88 for engaging with the four, second stage planet gears 56. As best seen in FIG. 2, the ring gear 82 includes several flats 90 on the end opposite the rotor 16 that engage with corresponding flats 92 in a hole 94 at the end of the cylinder bore 38 in the caliper housing 20. The ring gear 82 is axially locked in place with respect to the caliper housing 20 by a snap ring 95 that engages a portion of the ring gear 82 extending through the hole 94 in the caliper housing 20. By virtue of this mounting arrangement, the ring gear 82 is rotationally fixed relative to the rotational axis 51 of the ball screw 48 and extends into the ball screw 48 inside of the annular cylindrical wall 50 of the ball screw 48 along the rotational axis 51 of the ball screw 48.

The ball screw apparatus 36 of the exemplary embodiment also includes a first stage carrier 96 having a second stage sun gear 98 fixedly attached thereto for engaging the four, second stage planet gears 56. The first stage carrier 96 also supports four first stage planetary gears 100, journalled on four stub shafts 102, by bushings 104. The four, first stage planetary gears 100 also engage the internal gear teeth 88 of the ring gear 82. It should be noted that in the exemplary embodiment, the end wall 52 of the ball screw 48 includes a clearance hole 105 for passage of a portion of the second stage sun gear 98. In other embodiments of our invention, it may be desirable to have the end wall 52 of the ball screw 48 be completely closed.

The ball screw apparatus 36 further includes a first stage sun gear 106 on one end of an input shaft 108 of the planetary portion the gear train. The first stage sun gear 106 engages the four, first stage planet gears 100. An input spur gear 110 is attached to the other end of the input shaft 108, for engaging with a pinion gear (not shown) attached to the drive shaft of an electric motor 112.

Those skilled in the art will recognize that our invention provides a number of advantages over prior electric calipers and brake systems including prior electric calipers. For example, a ball screw apparatus, according to our invention, provides a high torque carrying capacity at the second stage carrier 54, in a manner that is compact and readily manufactured. Having the second stage carrier 54 formed integrally with the ball screw 48 as a closed end wall 52, and having the ball track 58 spaced away from the closed end wall 52 of the ball screw 48, provide a significantly thicker, stronger and more homogeneous juncture of the end wall 52 and the annular shaped side wall 50 of the ball screw 48. Having the end of the ball screw nut 40 closed, and formed integrally with the remainder of the ball screw nut 40, provides a smooth outer surface of the ball screw nut 40, to improve the life of the seal 46, and facilitates operations required to plate the outer surface of the annular wall 64 of the ball screw nut 40. Those skilled in the art will also readily recognize that, while the embodiments of our invention disclosed herein are presently considered to be preferred, various changes and modifications can be made without departing from the spirit and scope of the invention. The scope of the invention is indicated in the appended claims, and all changes or modifications within the meaning and range of equivalents are intended to be embraced therein.

1. A ball screw apparatus for an electric brake caliper, the ball screw apparatus comprising:
a cup-shaped ball screw having an annular cylindrical sidewall disposed about a rotational axis and closed at one axial end thereof by an end wall joined around an entire periphery thereof with the sidewall, the ball screw sidewall and endwall being integral portions of the same piece of the ball screw, with the end wall adapted to form a carrier for operatively supporting at least one planetary gear; and
a ball screw nut operatively engaged with the ball screw.

2. The ball screw apparatus of claim 1 wherein the sidewall of the ball screw defines an axial length of the ball screw and a ball track extending about the sidewall along the axial length of the ball screw from starting point that is adjacent to but axially spaced from the closed end of the ball screw

3. The ball screw apparatus of claim 2 wherein the ball track includes a ball return track.

4. The ball screw apparatus of claim 3 wherein:
the ball screw nut is cup-shaped and includes an annular cylindrical sidewall disposed about a rotational axis and closed at one axial end thereof by an end wall joined around an entire periphery thereof with the sidewall, the ball screw nut sidewall and endwall being integral portions of the same piece of the ball screw nut, with the side wall of the ball screw nut defining an inner surface of the ball screw nut sidewall having a ball track therein; and
the ball screw apparatus includes a plurality of balls residing concurrently in the ball tracks in the annular sidewalls of both the ball screw and the ball screw nut.

5. The ball screw apparatus of claim 4 further comprising a ring gear operatively engaged by the planet gear.

6. The ball screw apparatus of claim 4 wherein the ring gear is rotationally fixed relative to the rotational axis of the ball screw and extends into the ball screw inside of the annular cylindrical wall of the ball screw along the rotational axis of the ball screw.

7. The ball screw apparatus of claim 6 further comprising a thrust bearing operatively engaging the axial end of the ball screw opposite the closed end and adapted for reacting axial loads from the ball screw into a support structure.

8. The ball screw apparatus of claim 6 wherein:
the carrier formed by the end wall of the ball screw is a second stage carrier;
the ball screw apparatus includes at least one second stage planetary gear operatively supported by the second stage carrier;
the ring gear has a tubular shaped wall including an inner wall thereof defining internal gear teeth for engaging with the at least one second stage planet gear; and
the ball screw apparatus also includes a first stage carrier having a second stage sun gear fixedly attached thereto for engaging the at least one second stage planet gear, and operatively supporting at least one first stage planet gear operatively engaging the internal gear teeth of the ring gear; and
the ball screw apparatus further includes a first stage sun gear engaging the at least one first stage planet gear and adapted for connection to a drive motor.

9. The ball screw apparatus of claim 8 further including an electric drive motor drivingly connected to the first stage sun gear.

10. An electric caliper apparatus comprising:
a ball screw apparatus comprising a cup-shaped ball screw and a ball screw nut operatively engaged with the ball screw, the ball screw—having an annular cylindrical sidewall disposed about a rotational axis and closed at one axial end thereof by an end wall joined around an entire periphery thereof with the sidewall, the ball screw sidewall and endwall being integral portions of the same piece of the ball screw, with the end wall adapted to form a carrier for operatively supporting at least one planetary gear; and
an electric motor drivingly engaged with the carrier.

11. The electric caliper apparatus of claim 10 wherein the sidewall of the ball screw defines an axial length of the ball screw and a ball track extending about the sidewall along the axial length of the ball screw from starting point that is adjacent to but axially spaced from the closed end of the ball screw

12. The electric caliper apparatus of claim 11 wherein the ball track includes a ball return track.

13. The electric caliper apparatus of claim 12 wherein:
the ball screw nut is cup-shaped and includes an annular cylindrical sidewall disposed about a rotational axis and closed at one axial end thereof by an end wall joined around an entire periphery thereof with the sidewall, the ball screw nut sidewall and endwall being integral portions of the same piece of the ball screw nut, with the side wall of the ball screw nut defining an inner surface of the ball screw nut sidewall having a ball track therein; and
the ball screw apparatus includes a plurality of balls residing concurrently in the ball tracks in the annular sidewalls of both the ball screw and the ball screw nut.

14. The electric caliper apparatus of claim 13 further including a ring gear for engaging the planet gear.

15. The electric caliper apparatus of claim 14 wherein the ring gear is rotationally fixed relative to the rotational axis of the ball screw and extends into the ball screw inside of the annular cylindrical wall of the ball screw along the rotational axis of the ball screw.

16. The electric caliper apparatus of claim 15 further comprising a thrust bearing operatively engaging the axial end of the ball screw opposite the closed and adapted for reacting axial loads from the ball screw into a support structure.

17. The electric caliper apparatus of claim 15 wherein:
the carrier formed by the end wall of the ball screw is a second stage carrier;
the ball screw apparatus includes at least one second stage planetary gear operatively supported by the second stage carrier;
the ring gear has a tubular shaped wall including an inner wall thereof defining internal gear teeth for engaging with the at least one second stage planet gear; and
the ball screw apparatus also includes a first stage carrier having a second stage sun gear fixedly attached thereto for engaging the at least one second stage planet gear, and operatively supporting at least one first stage planet gear operatively engaging the internal gear teeth of the ring gear; and
the ball screw apparatus further includes a first stage sun gear engaging the at least one first stage planet gear and adapted for operative connection to the electric motor.

18. An electric brake apparatus comprising:
an electric caliper having a brake pad adapted to frictionally engage a rotor;
a ball screw apparatus comprising a cup-shaped ball screw and a ball screw nut operatively engaged with the ball screw, the ball screw having an annular cylindrical sidewall disposed about a rotational axis and closed at one axial end thereof by an end wall joined around an entire periphery thereof with the sidewall, the ball screw sidewall and endwall being integral portions of the same piece of the ball screw, with the end wall adapted to form a carrier for operatively supporting at least one planetary gear; and
an electric motor drivingly engaged with the ball screw apparatus and adapted to bias the ball screw nut into frictional engagement with the rotor.

19. The electric brake apparatus of claim 18 wherein:
the ball screw nut is cup-shaped and includes an annular cylindrical sidewall disposed about the rotational axis and closed at one axial end thereof by an end wall joined around an entire periphery thereof with the sidewall, the ball screw nut sidewall and endwall being integral portions of the same piece of the ball screw nut, with the side wall of the ball screw nut defining an inner surface of the ball screw nut sidewall having a ball track therein; and
the ball screw apparatus includes a plurality of balls residing concurrently in the ball tracks in the annular sidewalls of both the ball screw and the ball screw nut.

20. The electric brake apparatus of claim 19 wherein:
the ball screw apparatus further comprises a ring gear operatively engaged by the planet gear and rotationally fixed relative to the rotational axis of the ball screw, extending into the ball screw inside of the annular cylindrical wall of the ball screw along the rotational axis of the ball screw;
the carrier formed by the end wall of the ball screw is a second stage carrier;
the ball screw apparatus includes at least one second stage planetary gear operatively supported by the second stage carrier;
the ring gear has a tubular shaped wall including an inner wall thereof defining internal gear teeth for engaging with the at least one second stage planet gear; and
the ball screw apparatus also includes a first stage carrier having a second stage sun gear fixedly attached thereto for engaging the at least one second stage planet gear, and operatively supporting at least one first stage planet gear operatively engaging the internal gear teeth of the ring gear; and
the ball screw apparatus further includes a first stage sun gear engaging the at least one first stage planet gear and adapted for operative connection to the electric motor to be driven thereby.
